(19) United States
(12) Patent Application Publication
(10) Pub. No.: US 2015/0162618 A1
(43) Pub. Date: Jun. 11, 2015

(54) Sodium Secondary Battery Including Graphite Felt Formed with Grooves

(71) Applicant: SK Innovation Co., Ltd., Seoul (KR)

(72) Inventors: Young Shol Kim, Daejeon (KR); Ku Bong Chung, Daejeon (KR); Jeong Soo Kim, Daejeon (KR)

(21) Appl. No.: 14/529,389

(22) Filed: Oct. 31, 2014

(30) Foreign Application Priority Data
Nov. 1, 2013 (KR) 10-2013-0131930

(51) Int. Cl. H01M 4/66; H01M 10/054

(52) U.S. Cl. CPC H01M 4/663; H01M 10/054; H01M 2300/0065

(57) ABSTRACT

Provided is a sodium secondary battery including: a sodium ion conductive solid electrolyte separating an anode space and a cathode space from each other; an anode positioned in the anode space and containing sodium; a cathode solution positioned in the cathode space; and a cathode immersed in the cathode solution and including graphite felt formed with grooves arranged in parallel with each other in a surface of the graphite felt facing the solid electrolyte.

### CROSS-REFERENCE TO RELATED APPLICATION

This application claims priority to Korean Patent Application No. KR 10-2013-0131930 filed Nov. 1, 2013, the disclosure of which is hereby incorporated in its entirety by reference.

### TECHNICAL FIELD

The following disclosure relates to a sodium secondary battery, and more particularly, to a sodium secondary battery including graphite felt formed with grooves.

### BACKGROUND

In accordance with a rapid increase in the use of renewable energy, the necessity for an energy storage device using a battery has rapidly increased. Among these batteries, a lead battery, a nickel/hydrogen battery, a vanadium battery, and a lithium battery may be used. However, since the lead battery and the nickel/hydrogen battery have significantly low energy density, they require a large space in order to store the same capacity of energy therein. Further, in the case of the vanadium battery, the vanadium battery uses a solution containing a heavy metal, which causes environmental contamination, and a small amount of materials may move between an anode and a cathode through a membrane separating the anode and the cathode from each other, which deteriorates performance. Therefore, the vanadium battery cannot be commercialized on a large scale. The lithium battery having significantly excellent energy density and output characteristics is significantly advantageous in view of a technology. However, the lithium battery is disadvantageous in view of economic efficiency for being used as a secondary battery for large scale power storage due to scarcity of a lithium material.

In order to solve this problem, many attempts to use a sodium resource, which is sufficiently present on Earth, as a material of the secondary battery have been conducted. Among them, as disclosed in US Patent Laid-Open Publication No. 20030054255, a sodium-sulfur battery having a form in which a beta alumina having selective conductivity for a sodium ion is used, an anode is loaded with sodium, and a cathode is load with sulfur has been currently used as a large scale power storage.

However, in the existing sodium based secondary battery such as the sodium-sulfur battery or a sodium-nickel chloride battery, conductivity thereof and melting points of battery compositions should be considered. For example, the sodium-nickel chloride battery has an operation temperature of at least 250° C. or more, and the sodium-sulfur battery has an operation temperature of at least 300° C. or more. Due to this problem, there are many disadvantages in view of economical efficiency in manufacturing or operating the sodium based secondary battery while maintaining a temperature and sealability of the battery and reinforcing the safety thereof. In order to solve the above-mentioned problems, a room-temperature sodium based battery has been developed, but the output thereof is significantly low, such that the room-temperature sodium based battery has significantly low competitiveness as compared with the nickel-hydrogen battery or the lithium battery.

### RELATED ART DOCUMENT

### Patent Document

### U.S. Patent Laid-Open Publication No. 20030054255

### SUMMARY

An embodiment of the present invention is directed to providing a sodium secondary battery capable of preventing capacity from being decreased at the time of repeating charge and discharge cycles, operating at a low temperature, improving an output and a charge and discharge rate of the battery, stably maintaining charge and discharge cycle characteristics for a long period time, preventing degradation to improve a battery lifespan, and improving stability of the battery.

In one general aspect, a sodium secondary battery includes: a sodium ion conductive solid electrolyte separating an anode space and a cathode space from each other; an anode positioned in the anode space and containing sodium; a cathode solution positioned in the cathode space; and a cathode immersed in the cathode solution and including graphite felt formed with grooves arranged in parallel with each other in a surface of the graphite felt facing the solid electrolyte.

In one general aspect, A sodium secondary battery comprising: a sodium ion conductive solid electrolyte separating an anode space and a cathode space, an anode positioned in the anode space and containing sodium, a catholyte positioned in the cathode space, and a cathode including a graphite felt impregnated into the catholyte and provided with grooves disposed in parallel with each other and formed in a surface facing the solid electrolyte.

The groove may transverse the surface of the graphite felt facing the solid electrolyte.

The groove may cross the surface of the graphite felt facing the solid electrolyte.

The groove may have a uniform width in a depth direction.

The groove may have a tapered shape in which a width thereof is decreased in a depth direction.

The groove may be continuously formed.

A depth of the groove may be 5 to 95% based on a thickness (100%) of the graphite felt.

A width of the groove may be 0.1 to 30% based on a length (100%) of the graphite felt in a height direction.

The grooves may be arranged in parallel with each other in a height direction.

The graphite felt may have a hollow cylindrical or cylindrical shape, and the groove may form a closed curve.

A density of the groove corresponding to the number of grooves per unit length of the graphite felt may be 0.1 to 10 ea/cm.

The sodium secondary battery may further include a cylindrical metal housing of which one end is closed, and the other end is opened, wherein the cathode space and the anode space are partitioned from each other by a tube type solid electrolyte of which one end inserted into the metal housing is closed.

The sodium secondary battery may further include a cylindrical metal housing of which one end is closed and the other end is open, wherein the cathode space and the anode space are separated by the tubular solid electrolyte of which one end inserted into the metal housing is closed.

The cathode may further contain a transition metal attached or loaded in the graphite felt.

The cathode may further contain a transition metal adhered to, supported or impregnated in the graphite felt.

The cathode solution may contain: a metal halide corresponding to a halide of at least one metal selected from transition metals and Groups 12 to 14 metals; and a solvent dissolving the metal halide.

At the time of discharge, metal ions of the metal halide contained in the cathode solution may be converted into a metal to thereby be electroplated on the graphite felt, and at the time of charge, the metal electroplated on the graphite felt may be converted into the metal ions to thereby be dissolved in the cathode solution.

Metal ions of the metal halide contained in the catholyte are electrodeposited on the graphite felt as the metals at the time of being discharged, and the metals electrodeposited on the graphite felt are dissolved into the catholyte as the metal ions at the time of being charged.

### BRIEF DESCRIPTION OF THE DRAWINGS

FIGS. 1A and 1B are perspective views showing examples of graphite felt provided in a sodium secondary battery according to an exemplary embodiment of the present invention.

FIG. 2 is a perspective view showing another example of graphite felt provided in the sodium secondary battery according to the exemplary embodiment of the present invention.

FIGS. 3A and 3B are perspective views showing examples of graphite felt provided in the sodium secondary battery according to the exemplary embodiment of the present invention.

FIG. 4 is a perspective view showing another example of graphite felt provided in the sodium secondary battery according to the exemplary embodiment of the present invention.

FIG. 5A is a perspective view showing another example of the graphite felt provided in the sodium secondary battery according to the exemplary embodiment of the present invention and FIG. 5B is a cross-sectional view taken along line A-A′ of FIG. 5A.

FIG. 6A is a perspective view showing another example of the graphite felt provided in the sodium secondary battery according to the exemplary embodiment of the present invention and FIG. 6B is a cross-sectional view taken along line A-A′ of FIG. 6A.

FIG. 7A is a perspective view showing another example of the graphite felt provided in the sodium secondary battery according to the exemplary embodiment of the present invention and FIG. 7B is a cross-sectional view taken along line A-A′ of FIG. 7A.

FIG. 8 is a cross-sectional view showing an example of the sodium secondary battery according to the exemplary embodiment of the present invention.

FIG. 9 is a cross-sectional view showing another example of the sodium secondary battery according to the exemplary embodiment of the present invention.

### DETAILED DESCRIPTION OF EMBODIMENTS

Hereinafter, a sodium secondary battery according to the present invention will be described in detail with reference to the accompanying drawings. The following accompanying drawings are provided by way of example so that the idea of the present invention can be sufficiently transferred to those skilled in the art to which the present invention pertains. Therefore, the present invention is not limited to the drawings to be provided below, but may be modified in many different forms. In addition, the drawings to be provided below may be exaggerated in order to clarify the scope of the present invention. Like reference numerals denote like elements throughout the specification.

Here, technical terms and scientific terms used in the present specification have the general meaning understood by those skilled in the art to which the present invention pertains unless otherwise defined, and a description for the known function and configuration unnecessarily obscuring the present invention will be omitted in the following description and the accompanying drawings.

A sodium secondary battery according to the present invention includes a sodium ion conductive solid electrolyte separating an anode space and a cathode space from each other, an anode positioned in the anode space and containing sodium, a cathode solution positioned in the cathode space, and a cathode immersed in the cathode solution and including graphite felt formed with grooves arranged in parallel with each other in a surface of the graphite felt facing the solid electrolyte.

In the sodium secondary battery according to an exemplary embodiment of the present invention, a cathode current collector may include the graphite felt, and the sodium secondary battery may be a battery in which a metal is electroplated on the cathode current collector at the time of charging or discharging the battery. More particularly, the sodium secondary battery may be a battery in which metal ions contained in the cathode solution are converted into a metal to thereby be electroplated on the cathode current collector.

Since the graphite felt does not react with a battery component such as the cathode solution, the graphite felt is chemically stable and has high porosity, such that a wide reaction area may be provided, and at the same time, a large amount of the cathode solution may be immersed therein.

However, in the case of using the graphite felt as the cathode current collector, when the metal is electroplated on the graphite felt at the time of a charge or discharge reaction of the battery, the electroplating is generated on the surface of the graphite felt, such that pores of the graphite felt may be closed by the electroplated metal. In addition, an electroplating rate may be changed according to regions where the electroplating is generated by a non-uniform electric field and potential caused by the porous structure. In the case in which pores of the surface of the graphite felt are first closed by the electroplating, the reaction area where a battery reaction may occur during a charging or discharging process may be significantly decreased, and in the case in which non-uniform electroplating is aggravated, the electroplated metals may be detached in a particulate phase from the current collector, such that a permanent capacity loss may be generated. In addition, non-uniform dissolution may be generated by non-uniform electroplating, such that metals that are not yet dissolved even in this dissolution process may be detached in the particulate phase from the current collector. Therefore, as the charge and discharge cycle is repeated, the permanent capacity loss of the battery may be further increased.

In the sodium secondary battery according to the present invention, a decrease in the reaction area caused by non-uniform electroplating and dissolution of the metal and the closing of pores positioned in the surface of the graphite felt may be prevented by applying the graphite felt having excellent chemical stability, a wide reaction area, and a large loading amount of the cathode solution, and having the grooves formed in parallel with each other in the surface of the graphite felt facing the solid electrolyte as the cathode current collector.

In detail, the grooves formed in the graphite felt may increase a contact area between the graphite felt and the cathode solution and serve to provide a large amount of nucleation site when the metal is electroplated. At the same time, even though the electroplated metal particles are detached from the graphite felt, the detached metal particles are positioned in the grooves in a state in which the detached metal particles physically contact with graphite, thereby making it possible to physically prevent the metal particles from being detached to the outside of the graphite felt.

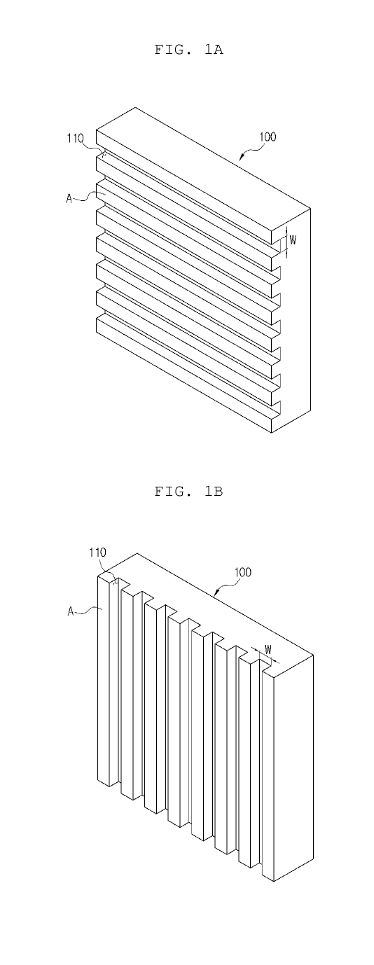

FIGS. 1A and 1B are perspective views showing examples of graphite felt 100 in a sodium secondary battery according to an exemplary embodiment of the present invention. As shown in FIGS. 1A and 1B, a plurality of grooves 110 arranged in parallel with each other so as to be spaced apart from each other may be formed in a surface A of the graphite felt 100 facing a solid electrolyte. The grooves 110 formed in the graphite felt 100 may transverse the surface A of the graphite felt. ‘The groove 110 transversing the surface A of the graphite felt 100’ may mean that in the case in which the graphite felt has a plate shape, both ends of the groove 110 come in contact with two random corners among corners of the graphite felt 100.

Specifically, as shown in FIGS. 1A and 1B, grooves transversing the surface of the graphite felt may be formed, wherein both ends of a single groove come in contact with two corners of the graphite felt opposing each other. More specifically, as shown in FIG. 1A, grooves transversing the surface of the graphite felt in a direction vertical to a height direction may be formed in the graphite felt. More specifically, as shown in FIG. 1B, grooves transversing the surface of the graphite felt in a direction parallel with the height direction may be formed in the graphite felt.

Although the case in which the graphite felt has a plate shape is shown in FIGS. 1A and 1B, the graphite felt may have a shape suitable for a structure of the sodium secondary battery. As an example, the graphite felt may have a hollow cylindrical shape, and ‘grooves transversing the surface of the graphite felt” may mean that in the case in which the graphite felt has the hollow cylindrical shape, grooves are formed in an inner or outer surface of a hollow cylinder, which is a surface facing the solid electrolyte, and both ends of the formed groove come in contact with each other to form a closed curve.

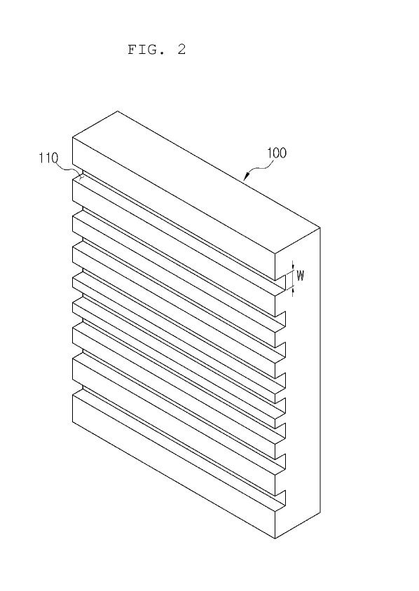

As shown in the examples of FIGS. 1A and 1B, the plurality of grooves formed in the surface A of the graphite felt may be arranged in parallel with each other so as to be spaced apart from each other by a predetermined interval. In addition, as an example of the graphite shown in FIG. 2, a plurality of grooves formed in the surface A of the graphite felt may be arranged in parallel with each other so as to be spaced apart from each other, but a spaced distance between the grooves may be different.

In a large capacity sodium secondary battery, at the time of the charge and discharge reaction, a flux of sodium ions moving to a cathode space or anode space through a sodium ion conductive solid electrolyte may be changed depending on a position, and a magnetic field formed through a current collector may also be changed depending on the position. In consideration of non-uniformity caused by large capacity, grooves having a relatively longer spaced distance therebetween may be arranged in parallel with each other so as to be spaced apart from each other in a region of the graphite felt corresponding to a region at which a relatively lower sodium ion flux and/or a smaller electric field is formed, and grooves having a relatively shorter spaced distance therebetween may be arranged in parallel with each other so as to be spaced apart from each other in a region of the graphite felt corresponding to a region at which a higher sodium ion flux and/or a relatively larger electric field is formed.

As a specific example, a spaced interval between grooves formed in an upper edge region and/or a lower edge region of the surface of the graphite felt in a height direction corresponding to a gravity direction may be wider than a spaced interval between grooves formed in a central region as shown in FIG. 2. Although the case in which the spaced interval between the grooves are changed according to the region is shown in FIG. 2, the spaced interval may be gradually decreased from upper and lower edges of the graphite felt to the center thereof.

In the sodium secondary battery according to the exemplary embodiment of the present invention, a width w of the groove formed in the graphite felt may be 0.1 to 30% based on the shortest distance (100%) between two corners of the graphite felt opposing each other. In detail, the width w may be 0.1 to 30% based on a length (100%) of the graphite felt in the height direction corresponding to the gravity direction. In the case in which the width is excessively wide (more than 30%), an effect of increasing the nucleation site of the electroplated metal by the groove may become insignificant, and in the case in which electroplated metal particles are detached in the groove, the detached metal particles are released outside the groove, such that the detached metal particles may be permanently separated from the graphite felt. In addition, the width w of the groove is excessively narrow (less than 0.1%), the materials (cathode solution and sodium ions) may not smoothly move in the groove. As a specific and non-restrictive example, based on the large capacity sodium secondary battery, the length of the graphite felt in the height direction may be 100 cm, and the width of the groove may be 0.1 to 30 cm.

In this case, the plurality of grooves formed in the graphite felt may have widths equal to or different from each other.

As in the examples shown in FIGS. 1A to 2, in the sodium secondary battery according to the exemplary embodiment of the present invention, the groove may have a constant width w in a depth direction. In this case, the depth direction of the groove may refer to a thickness direction from the surface A of the graphite felt facing the solid electrolyte to the opposite surface of the surface A.

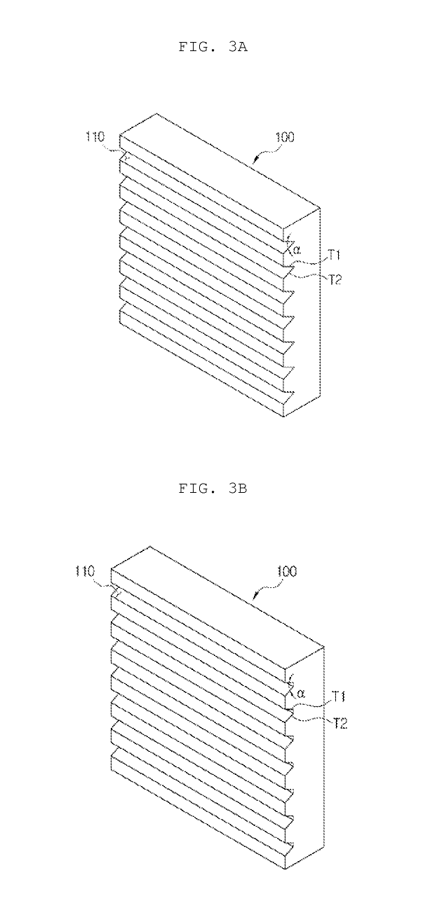

As in examples shown in FIGS. 3A and 3B, in the sodium secondary battery according to the exemplary embodiment of the present invention, the groove may have a tapered shape in which the width thereof is decreased in the depth direction. When the groove has the tapered shape in which the width thereof is decreased in the depth direction, even though the depth of the groove is deep, a flow of the cathode solution and movement of the materials may not be inhibited.

More specifically, as shown in FIGS. 3A and 3B, the width of the groove may be continuously decreased in the depth direction, and a taper angle (α), which is an angle between two tapered sides T1 and T2 of the groove, may be 5° to 120°. In the case in which the taper angle (a) is excessively small (less than 5°), an effect of improving movement of the cathode solution and materials in the groove may become insignificant, and in the case in which the taper angle (α) is excessively large (more than 120°), when the electroplated metal particles are detached in the groove, the detached metal particles may be released outside the groove to thereby move to the cathode solution.

The groove having the tapered shape may have a linear or plate shape at a lowest point in the depth direction. In detail, as the example shown in FIG. 3A, in the groove having the tapered shape, two tapered sides T1 and T2 may come in contact with each other in the graphite felt, thereby forming a corner between the two tapered sides T1 and T2. Independently, as in the example shown in FIG. 3B, in the groove having the tapered shape, a bottom surface is formed at the lowest point in the depth direction, and two tapered sides may come in contact with the bottom surface, respectively.

As described above, in the case in which the groove has the tapered shape, the maximum width of the groove, that is a width of the groove at the surface of the graphite felt, may be 0.1 to 30% based on the length (100%) of the graphite felt in the height direction.

In the sodium secondary battery according to an exemplary embodiment of the present invention, the groove formed in the graphite felt may have a tapered shape, and the grooves may be continuously formed in the graphite felt. That is, the grooves having the tapered shape may be continuously arranged in parallel with each other while coming in contact with each other in a state in which the grooves are not spaced apart from each other.

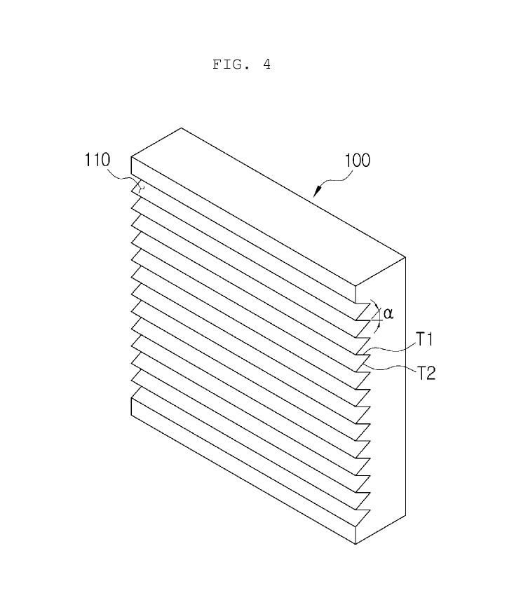

FIG. 4 is a perspective view showing an example of the graphite felt in which the grooves having the tapered shape come in contact with each other and are arranged in parallel with each other. As shown in FIG. 4, a plurality of grooves having the tapered shape may be continuously formed in the surface of the graphite felt facing the solid electrolyte in a state in which the grooves are not spaced apart from each other. That is, peaks formed at the surface of the graphite felt by a trough corresponding to the lowest point of the groove in the depth direction and two grooves coming in contact with each other may alternate with each other to thereby be regularly and continuously formed.

The cases in which the graphite felt has an entirely plate shape are shown in FIG. 1A to FIG. 4 by way of example, but the entire shape of the graphite felt may be changed according to an entire structure and shape of a secondary battery to be designed.

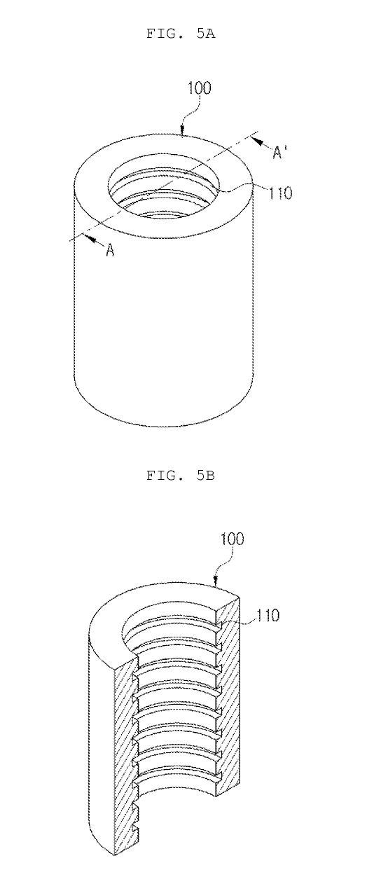

FIG. 5A is a perspective view showing another example of the graphite felt provided in the sodium secondary battery according to the exemplary embodiment of the present invention and FIG. 5B is a cross-sectional view taken along line A-A′ of FIG. 5A. As shown in FIGS. 5A and 5B, the graphite felt 100 may have a hollow cylinder shape, and the surface of the graphite felt facing the solid electrolyte may be an inner surface of a hollow cylinder.

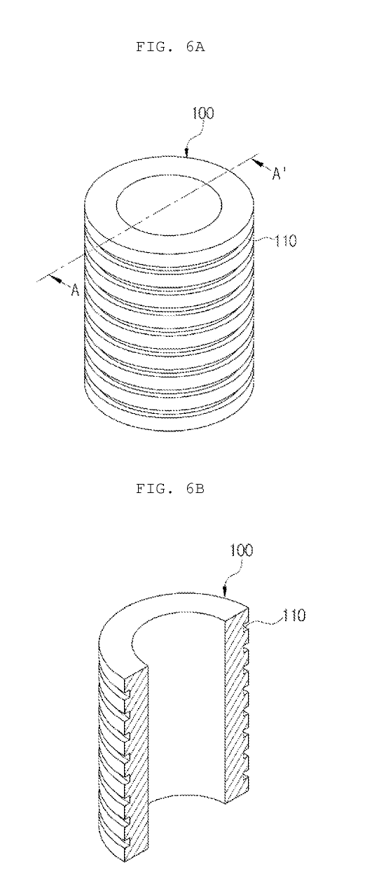

FIG. 6A is a perspective view showing another example of the graphite felt provided in the sodium secondary battery according to the exemplary embodiment of the present invention and FIG. 6B is a cross-sectional view taken along line A-A′ of FIG. 6A. As shown in FIGS. 6A and 6B, the graphite felt 100 may have a cylindrical shape, and the surface of the graphite felt facing the solid electrolyte may be an outer surface of a cylinder.

In the case in which the graphite felt has the hollow cylindrical or cylindrical shape, as shown in FIGS. 5A to 6B, grooves of which both ends come in contact with each other to form a closed curve may be arranged in parallel with each other in the surface of the graphite felt facing the solid electrolyte.

In addition, although the cases in which the grooves are formed vertically to the height direction corresponding to the gravity direction are shown in FIGS. 5A to 6B, even in the case in which the graphite felt has a hollow cylindrical or cylindrical shape, as described based on FIG. 1B, grooves parallel with the gravity direction may be formed.

In addition, the cases in which the grooves formed in the surface of the graphite felt are constantly spaced apart from each other and arranged in parallel with each other are shown in FIGS. 5A to 6B, even in the case in which the graphite felt has the hollow cylindrical or cylindrical shape, a spaced interval between grooves formed in the upper and lower regions in the height direction corresponding to the gravity direction may be larger than a spaced interval between grooves formed in a central region as described based on FIG. 2. In addition, the spaced interval between grooves may be gradually decreased from an upper edge to the center and/or a lower edge to the center.

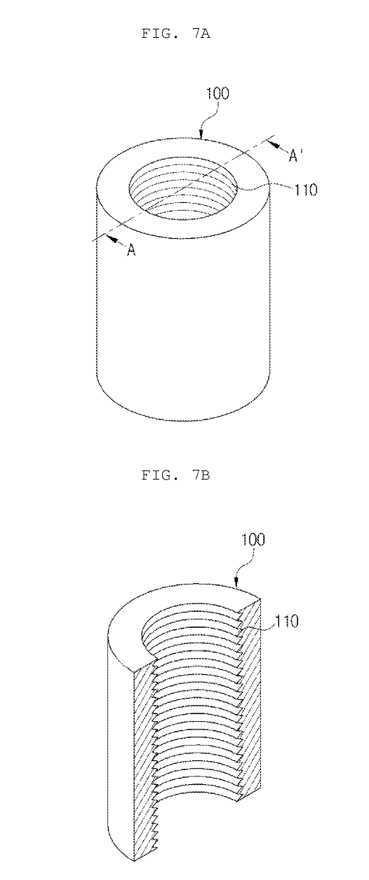

FIG. 7A is a perspective view showing an example of the graphite felt in which grooves having a tapered shape come in contact with each other and continuously arranged in parallel with each other when the graphite felt has a hollow cylindrical shape and a surface of the graphite felt facing the solid electrolyte is a inner surface of a cylinder, and FIG. 7B is a cross-sectional view taken along line A-A′ of FIG. 7A.

In the sodium secondary battery according to the exemplary embodiment of the present invention, a depth of the groove may be 5 to 95% based on a thickness (100%) of the graphite felt. In this case, as described above, the thickness of the graphite felt may mean the length (thickness) between the surface of the graphite felt facing the solid electrolyte and the opposite surface thereof, and the depth of the groove may mean a length of the groove from the surface of the graphite felt facing the solid electrolyte in a direction toward the opposite surface. In the case in which the depth of the groove formed in the graphite felt is less than 5% based on the thickness of the graphite felt, an effect of providing a metal electroplating site by the groove may become insignificant, and metal particles capable of being detached in the groove may be released outside the groove. In the case in which the depth of the groove is more than 95% based on the thickness of the graphite felt, physical stability of the graphite felt may be deteriorated, and the materials including the cathode solution may not smoothly move in the groove. As a specific and non-restrictive example, based on the large capacity sodium secondary battery, the thickness of the graphite felt may be 4 cm, and the depth of the groove may be 0.2 to 3.8 cm.

In the sodium secondary battery according to the exemplary embodiment of the present invention, a density of the groove, which is the number of grooves per unit length of the graphite felt, may be 0.1 ea/cm or more. In this case, the unit length of the graphite felt may be a unit length of the graphite felt in an arrangement direction of the grooves arranged in parallel with each other, and may be a unit length of the graphite felt in a direction vertical to the groove based on a single groove.

More specifically, in view of providing the nucleation site at the time of metal electroplating, the higher density of the groove, the better. When the grooves having the above-mentioned width (tapered grooves) are continuously formed while coming in contact with each other, the grooves may have the highest density (maximum density). In the case in which the grooves are arranged so as to be spaced apart from each other, the density of the groove may be smaller than the maximum density of the groove. In this case, the density of the groove is a little decreased, but physical stability of the graphite felt may be improved. Here, the density of the groove may be at least 0.1 ea/cm or more, and in the case in which the density of the groove is less than 0.1 ea/cm, an effect of providing the nucleation site at the time of metal electroplating may become insignificant. specifically, the density of the groove may be 0.1 to 10 ea/cm, More specifically, the density of the groove may be 0.3 to 5 ea/cm.

An entire shape of the graphite felt provided in the sodium secondary battery according to the exemplary embodiment of the present invention may be suitably selected and changed according to a structure of a battery to be designed.

More specifically, in the case in which the battery to be designed is a plate type battery, the graphite felt having an entirely plate shape based on FIGS. 1 to 4 may be used as the cathode current collector, but in the case in which the battery to be designed is a non-plate type battery (for example, a tube type battery), the graphite felt described based on FIGS. 5A to 7B may be used as the cathode current collector. More specifically, in the case in which the battery to be designed is a tube type battery and a cathode current collector is positioned at the center of a tube structure, the graphite felt described based on FIGS. 6A and 6B may be used as the cathode current collector, and in the case in which the battery to be designed is a tube type battery and a current collector is positioned adjacently to an outer portion of a tube structure, the graphite felt described based on FIGS. 5A and 5B and FIGS. 7A and 7B may be used as the cathode current collector.

In the sodium secondary battery according to the exemplary embodiment of the present invention, the cathode current collector including the graphite felt serves to collect or supply charges (electrons) and make an electric connection to the outside of the battery. This electric connection to the outside of the battery may be made through an opposite surface, which is a surface opposing the surface of the graphite felt facing the solid electrolyte. In detail, the current collector may include the graphite felt and a metal membrane coming in contact with the opposite surface of the graphite felt, and the electric connection to the outside of the battery may be made by the metal membrane coming in contact with the opposite surface. In this case, the metal membrane coming in contact with the opposite surface may be a metal membrane separately provided for the cathode current collector or a part of the existing component of the battery. In this case, the existing component of the battery may include a metallic battery case, and the case in which the metal membrane is a part of the battery case may include the case in which the opposite surface of the graphite felt is positioned while coming in contact with the battery case.

As described above, the sodium secondary battery according to the exemplary embodiment of the present invention may have a plate type structure or tube type structure depending on a shape of the sodium ion conductive solid electrolyte separating and partitioning the anode space and the cathode space from each other, but the sodium secondary battery may have any structure as long as the structure is generally known in the art.

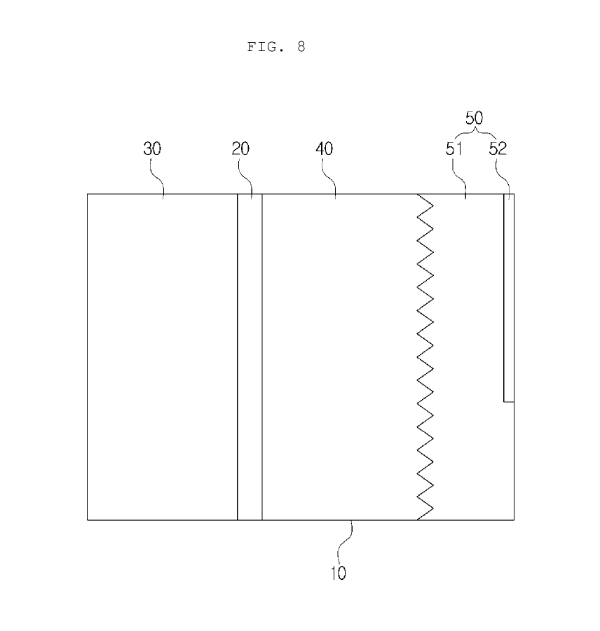

FIG. 8 is a cross-sectional view showing the case in which the sodium secondary battery according to the exemplary embodiment of the present invention has a plate type structure, based on the case in which an anode active material is molten sodium. As shown in FIG. 8, the sodium secondary battery according to the exemplary embodiment of the present invention may include a battery case 10 separating battery components from the outside, a solid electrolyte 20 partitioning and separating an internal space of the battery case into a cathode space and an anode space, an anode 30 positioned in the anode space and containing sodium, a cathode solution 40 positioned in the cathode space, and a cathode current collector 50 including the above-mentioned graphite felt 51 immersed in the cathode solution. In this case, the surface of the graphite felt coming in contact with the cathode solution may be a surface facing the solid electrolyte. In addition, the cathode current collector 50 may further include a metal membrane 52, wherein the metal membrane 52 may be positioned while coming in contact with an opposite surface of the graphite felt 51. In addition, an anode current collector put in molten sodium, which is an anode active material, may be further provided in the anode space for electric connection between the outside of the battery and the anode and a flow of charges (for example, electrons).

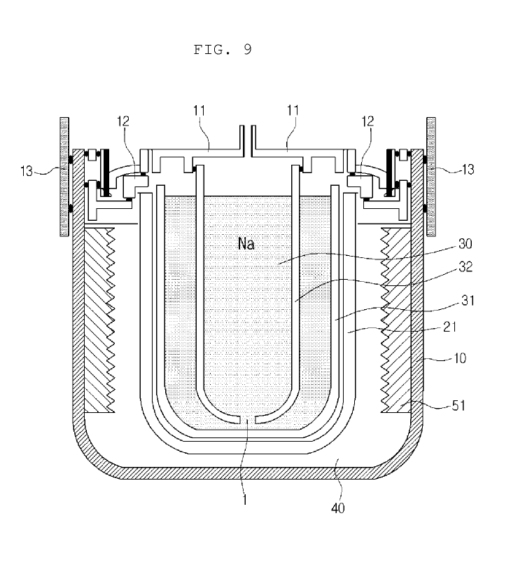

FIG. 9 is a cross-sectional view showing another example of the structure of the sodium secondary battery according to the exemplary embodiment of the present invention, based on the case in which an anode active material is molten sodium. FIG. 9 shows an example of the tube type sodium secondary battery, but the present invention is not limited to a physical shape of the battery. That is, the sodium secondary battery according to the present invention may have the plate type structure as shown in FIG. 8 or a structure of a general sodium based secondary battery.

As shown in FIG. 9, the sodium secondary battery according to the exemplary embodiment of the present invention may include a cylindrical metal housing (battery case 10) of which one end is closed and the other end is opened, and the cathode space and the anode space may be partitioned from each other by a tube type solid electrolyte 20 of which one end inserted into the metal housing 10 is closed. Although the case in which an empty space between the metal housing 10 and the solid electrolyte 20 is the cathode space is shown in FIG. 9 by way of example, the empty space between an internal center of the metal housing 10 and the solid electrolyte 20 may be an cathode space according to a design of the secondary battery.

In detail, the sodium secondary battery according to the exemplary embodiment of the present invention may include a cylindrical metal housing (battery case 10) having a closed lower end and an opened upper end, a tube shaped solid electrolyte (hereinafter, a tube type solid electrolyte 21) having a closed lower end, a safety tube 31, and a wicking tube 32, which are sequentially positioned in the metal housing 10 from an outer side of the metal housing 10 toward an inner side thereof.

More specifically, the wicking tube 32 positioned at the innermost portion, that is, the center of the metal housing 10, may have a tube shape in which a through-hole 1 is formed at a lower end thereof, and the safety tube 31 may be positioned at an outer side of the wicking tube 32 and have a structure in which the safety tube 31 encloses the wicking tube 32 while being spaced apart from the wicking tube 31 by a predetermined distance.

An anode 30 containing molten sodium is provided in the wicking tube 32 and may have a structure in which it fills an empty space between the wicking tube 32 and the safety tube 31 through the through-hole 1 formed at a lower portion of the wicking tube 32.

A dual structure of the wicking tube 32 and the safety tube 31 is a structure in which a violent reaction between cathode materials and anode materials may be prevented when the tube type solid electrolyte 20 is damaged and a level of the molten sodium may be constantly maintained by capillary force even at the time of discharge.

The tube type solid electrolyte 20 is positioned at an outer side of the safety tube 31 so as to enclose the safety tube 31 and may be a tube shaped solid electrolyte having selective permeability to the sodium ion (Na⁺).

A cathode solution 40 and graphite felt 51 may be provided in a space between the tube type solid electrolyte 20 enclosing the safety tube 31 and the metal housing 10.

That is, the sodium secondary battery according to the exemplary embodiment of the present invention may have a concentric structure in which the wicking tube 32, the safety tube 31, the tube type solid electrolyte 20, and the metal housing 10 are sequentially positioned from the inner side to the outer side. Here, the anode 30 containing the molten sodium may be loaded in the wicking tube 32, the cathode solution 40 may be provided in the space between the tube type solid electrolyte 20 and the metal housing 10, and the graphite felt 51 may be provided so as to be immersed in the cathode solution 40.

As shown in FIG. 9, based on a charge state, the cathode solution 40 and the graphite felt 51 may be positioned in the cathode space, and based on a discharge state, the cathode solution 40 and the graphite felt 51 on which a metal is electroplated may be positioned in the cathode space.

As shown in FIG. 9, the graphite felt 51 positioned in the cathode space of the metal housing 10 may be positioned so that the opposite surface comes in contact with an inner wall of the metal housing 10. In this case, the metal housing 10 may serve as a conductor for electric connection to the outside of the battery at an anode portion in addition to the case and serve to apply external potential to the graphite felt 51.

Although a shape in which the graphite felt fills a predetermined part of the cathode space is shown in FIG. 9, the cathode solution may be impregnated in pores of the graphite felt due to porosity of the graphite felt, such that the surface of the graphite felt facing the solid electrolyte may come in contact with the solid electrolyte. In detail, the graphite felt may have a hollow cylindrical shape, and the solid electrolyte, in detail, the tube type solid electrolyte 20 may be positioned in a hollow part of the graphite felt. The tube type solid electrolyte 20 positioned in the hollow part of the graphite felt 51 comes in contact with the graphite felt 51, such that the graphite felt 51 may fill the entire cathode space. Alternatively, the graphite felt 51 and the tube type solid electrolyte 20 are spaced apart from each other by a predetermined distance, such that the graphite felt may fill the part of the cathode space. In this case, the opposite surface of the graphite felt may come in contact with an inner side surface of the metal housing.

In the case in which the graphite felt has the hollow cylindrical shape, a thickness direction of the graphite felt may correspond to a shortest direction between a side surface of the tube type solid electrolyte 20 adjacent to the cathode and the inner side surface of the metal housing 10.

The sodium secondary battery according to the exemplary embodiment of the present invention may further include a cover 11 positioned on the metal housing 10 to close an inner portion of the metal housing, an insulator 12 having a ring shape and positioned at an upper side of the metal housing 10 to electrically insulate between the metal housing 10 and the tube type solid electrolyte 20, and an electrode terminal 13 positioned at a circumference of an upper end of the metal housing 10. Further, in order to minimize evaporation of liquid-state components, immediately after manufacturing the battery, internal pressure of the battery closed by the cover 11 may be 15 psi or more, and the opposite surface of the graphite felt 51 may be electrically connected to the metal housing 10. Furthermore, although not shown, a general anode current collector may be input through a through-hole of the cover so as to be immersed in the anode active material containing the molten sodium loaded in the wicking tube 32 at a predetermined region.

The sodium secondary battery according to the present invention may include the anode containing sodium, the cathode immersed in the cathode solution and including the above-mentioned graphite felt as the cathode current collector, and the sodium ion conductive solid electrolyte separating the anode and the cathode solution from each other.

That is, the sodium secondary battery according to the exemplary embodiment of the present invention includes the sodium ion conductive solid electrolyte separating the anode space and the cathode space from each other, the anode positioned in the anode space and containing sodium, the cathode solution positioned in the cathode space, and the cathode immersed in the cathode solution and including the above-mentioned graphite felt as the current collector.

The sodium secondary battery according to the exemplary embodiment of the present invention may be a battery in which electroplating of the metal is generated at the cathode during a battery charge or discharge process. More specifically, the sodium secondary battery may be a battery in which the electroplating of the metal is generated at the cathode during the battery discharge process. In this case, the electroplated metal may be at least one metal selected from a group consisting of transition metals and Groups 12 to 14 metals.

More specifically, an electrochemical (charge and discharge) reaction of the battery may occur between sodium; at least one metal selected from the transition metals and Groups 12 to 14 metals (hereinafter, referred to as a cathode active metal); and halogen. In addition, the cathode solution may contain a solvent dissolving a sodium halide, a cathode active metal halide, and a halide of at least one metal selected from the group consisting of the alkali metals, the transition metals, and Groups 12 to 14 metals.

That is, the sodium secondary battery according to the exemplary embodiment of the present invention may include the anode containing sodium; the cathode solution containing the solvent dissolving an alkali metal halide and the cathode active metal halide; the cathode including the above-mentioned graphite felt as the cathode current collector and immersed in the cathode solution; and the sodium ion conductive solid electrolyte separating the anode and the cathode solution from each other.

In this case, the alkali metal may include lithium (Li), sodium (Na), and potassium (K), the transition metal may include titanium (Ti), vanadium (V), chromium (Cr), manganese (Mn), iron (Fe), cobalt (Co), nickel (Ni), and copper (Cu), and Groups 12 to 14 metals may include zinc (Zn), aluminum (Al), cadmium (Cd), and tin (Sn).

In the sodium secondary battery according to the exemplary embodiment of the present invention, a charge reaction is carried out according to the following Reaction Formula 1, and a discharge reaction is carried out according to the following Reaction Formula 2, and at the time of charging and discharging the battery, sodium halide and cathode active metal halide of Reaction Formulas 1 and 2 may be dissolved in the cathode solution to thereby be in a liquid-state.

mNaX+M→mNa+MXₘ (Reaction Formula 1)

mNa+MXₘ→mNaX+M (Reaction Formula 2)

In Reaction Formulas 1 and 2, M is at least one metal (cathode active metal) selected from the transition metals and Groups 12 to 14 metals, X is a halogen atom, and m is a natural number of 1 to 4. In detail, in Reaction Formulas and 2, m may be a natural number corresponding to a positive valence of the metal M.

More specifically, in the sodium secondary battery according to the exemplary embodiment of the present invention, the cathode may be the above-mentioned graphite felt and the cathode solution itself, based on the charge state of the battery by the charge reaction according to Reaction Formula 1. That is, based on the charge state, the cathode in a solid state may be formed of only the cathode current collector. Based on the discharge state of the battery by the discharge reaction according to Reaction Formula 2, the cathode may be the cathode current collector including the graphite felt on which the cathode active metal is electroplated from the cathode solution, that is, the graphite felt on which the cathode active metal is attached or loaded by electroplating the cathode active metal.

In the sodium secondary battery according to the exemplary embodiment of the present invention, as the charge and discharge are repeatedly performed, metal ionization that the cathode active metal electroplated on the graphite felt, which is the current collector (cathode current collector), is converted into cathode active metal ions to thereby be dissolved in the cathode solution, and reduction that the dissolved cathode active metal ions are electroplated on the graphite felt (cathode current collector) again may be repeatedly performed.

In describing the sodium secondary battery according to the exemplary embodiment of the present invention, for clear understanding, the cathode and the charge and discharge reaction are described based on the reaction products or materials (the sodium halide, the cathode active metal halide, or the like) at the time of the charge and discharge reaction of Reaction Formulas 1 and 2. However, according to the present invention, as all of the reaction products of the sodium halide and the cathode active metal halide except for the electroplated metal exist in a state in which the reaction products are dissolved in the solvent, the sodium halide may be interpreted as the sodium ion and halide ion, and the cathode active metal halide may be interpreted as ions of at least one metal (cathode active metal) selected from the transition metals and Groups 12 to 14 metals and the halide ion.

As described above, as the cathode current collector includes the graphite felt, a significantly wide reaction area may be provided due to a significantly high porosity, and a large amount of the cathode solution may be put in the graphite felt. In addition, as the grooves are formed in the surface of the graphite felt adjacent to the solid electrolyte transferring the sodium ion from the anode to the cathode, a permanent decrease in capacity caused by non-uniform metal electroplating and detachment of the electroplated metal may be prevented by allowing the metal to be electroplated in the graphite felt.

In the sodium secondary battery according to the exemplary embodiment of the present invention, a concentration of the active material containing the cathode active metal halide and/or the sodium halide that are dissolved in the solvent of the cathode solution may be directly related to an amount of the material capable of participating in the electrochemical reaction of the battery and affect energy capacity per unit volume of the battery and conductivity of the ions (including sodium ions) in the cathode solution.

In the sodium secondary battery according to the exemplary embodiment of the present invention, the cathode solution may contain the active material at a concentration of 0.1 to 10M, preferably, 0.5 to 10M, more preferably, 1 to 6M, and most preferably 2 to 5M.

More specifically, in the sodium secondary battery according to the exemplary embodiment of the present invention, the cathode solution may contain the cathode active metal halide at a concentration of 0.1 to 10M, preferably, 0.5 to 10M, more preferably, 1 to 6M, and most preferably 2 to 5M. According to the charge or discharge state of the battery, the cathode active metal may exist in the cathode solution in an ionic state or be electroplated on the cathode current collector, such that an ionic concentration of the cathode active metal in the cathode solution may be changed. Here, the concentration of the cathode active metal halide in the cathode solution as described above may be a concentration based on the charge state.

Based on the charge state, in the case in which the cathode active metal halide has an excessively low concentration of less than 0.1, conductivity of the ions participating in the electrochemical reaction of the battery such as the sodium ion is excessively decreased, such that efficiency of the battery may be decreased, and capacity itself of the battery may be significantly low. Further, in the case in which the concentration of the cathode active metal halide is more than 10M, conductivity of the sodium ion may be decreased by the metal ion having the same charge as that of the sodium ion. However, ionic conductivity in the cathode solution may be adjusted by additionally adding an additive capable of increasing conductivity of the sodium ion while not participating in a net reaction of the battery, such as excess sodium halide to be described below, and the concentration of the cathode active metal halide may be adjusted according to the use of the battery and the design capacity thereof.

In the sodium secondary battery according to the exemplary embodiment of the present invention, the concentration of the sodium halide may also be determined by the concentration of the cathode active metal halide in the cathode solution according to the above-mentioned Reaction Formula 2, but in order to improve conductivity of the sodium ion in the cathode solution, the cathode may further contain a sodium halide together with the cathode active metal halide based on the charge state.

More specifically, according to the exemplary embodiment of the present invention, when the charge and discharge reactions of the battery represented by Reaction Formulas 1 and 2 are performed, in order to improve conductivity of the sodium ion and induce a more rapid charge or discharge reaction in the cathode solution containing the cathode active metal ion having a predetermined concentration, the cathode may contain the sodium ion and the halide ion at amounts larger than those determined by the discharge reaction according to the Reaction Formula 2.

Therefore, the cathode solution may contain the cathode active metal halide and the sodium halide that are dissolved in the solvent. In detail, the cathode solution in the charge state may contain the cathode active metal halide and the sodium halide that are dissolved in the solvent. Therefore, a liquid-state cathode in the charge state may contain the metal ion, the sodium ion, and the halide ion.

In the sodium secondary battery according to the exemplary embodiment of the present invention, the cathode solution in the charge state may further contain 0.1 to 3M of sodium halide based on 1M of the cathode active metal halide. Conductivity of the sodium ion in the cathode solution may be improved through an amount (molar ratio) of the sodium halide based on the cathode active metal halide, and the charge and discharge reactions of Reaction Formulas 1 and 2 may be rapidly and effectively carried out. Further, conductivity of the sodium ion and the reaction rate may be secured even though an operation temperature of the battery is low.

In the sodium secondary battery according to the exemplary embodiment of the present invention, the cathode active metal halide may be a halide defined as the following Chemical Formula 1.

MXₘ (Chemical Formula 1)

In Chemical Formula 1, M is at least one selected from nickel (Ni), iron (Fe), copper (Cu), zinc (Zn), cadmium (Cd), titanium (Ti), aluminum (Al), and tin (Sn), X is at least one selected from iodine (I), bromine (Br), chlorine (Cl), and fluorine (F), and m is a natural number of 1 to 4. Here, m may be a natural number corresponding to the valence of the metal.

In the sodium secondary battery according to the exemplary embodiment of the present invention, the alkali metal halide may be a sodium halide, wherein the sodium halide may be a halide defined as the following Chemical Formula 2.

NaX (Chemical Formula 2)

In Chemical Formula 2, X is at least one selected from iodine (I), bromine (Br), chlorine (Cl), and fluorine (F).

More specifically, in the sodium secondary battery according to the exemplary embodiment of the present invention, as the solvent of the cathode, any solvent may be used as long as the solvent may dissolve the sodium halide simultaneously with dissolving the metal halide, but a non-aqueous organic solvent, an ionic liquid, or a mixture thereof may be preferably used in view of improving ionic conductivity of sodium ion, stabilizing charge and discharge cycle characteristics, and improving preservation characteristics capable of preventing self-discharging.

As the non-aqueous organic solvent, at least one selected from alcohol based solvents, polyol based solvents, heterocyclic hydrocarbon based solvents, amide based solvents, ester based solvents, ether based solvents, lactone based solvents, carbonate based solvents, phosphate based solvents, sulfone based solvents, and sulfoxide based solvents may be used, and as the ionic liquid, at least one selected from imidazolium based ionic liquids, piperidinium based ionic liquids, pyridinium based ionic liquids, pyrrolidinium based ionic liquids, ammonium based ionic liquids, phosphonium based ionic liquids, and sulfonium based ionic liquids may be used.

More specifically, in the sodium secondary battery according to an exemplary embodiment of the present invention, as an example of a non-aqueous organic solvent capable of stably maintaining the liquid phase at an operation temperature and pressure of the secondary battery, easily diffusing the sodium ion introduced through the solid electrolyte, not generating undesired side-reactions, having stable solubility for the metal halide and sodium halide, stably performing the charge and discharge cycle for a long period time, and having excellent preservation characteristics, there is at least one selected from a group consisting of 1,2-ethanediol, 1,2-propanediol, 1,3-propanediol, 1,2-butanediol, 1,3-butandiol, 1,4-butanediol, 1,5-pentanediol, 2,2-dimethylpropane-1,3-diol, 2-butyl-2-ethylpropane-1,3-diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, glycerol, ethylene glycol, diethylene glycol, triethylene glycol, tetraethylene glycol, polyethylene glycol, propylene glycol, dipropylene glycol, tripropylene glycol, polypropylene glycol, formamide, N,N-dimethyl formamide, N,N-dimethyl acetamide, N,N-diethyl acetamide, N,N-dimethyl trifluoroacetamide, hexamethylphosphoramide, acetonitrile, propionitrile, butyronitrile, α-terpineol, β-terpineol, dihydro terpineol, N-methyl-2-pyrrolidone (NMP), dimethylsulfoxide, pyrrolidine, pyrroline, pyrrole, 2H-pyrrole, 3H-pyrrole, pyrazolidine, imidazolidine, 2-pyrazoline, 2-imidazoline, 1H-imidazole, triazole, isoxazole, oxazole, thiazole, isothiazole, oxadiazole, oxatriazole, dioxazole, oxazolone, oxathiazole, imidazoline-2-thione, thiadiazole, triazole, piperidine, pyridine, pyridazine, pyrimidine, pyrazine, piperazine, triazine, morpholine, thiomorpholine, indole, isoindole, indazole, benzisoxazole, benzoxazole, benzothiazole, quinoline, isoquinoline, cinnoline, quinazoline, quinoxaline, naphthyridine, phthalazine, benzoxazine, benzoadiazine, pterdine, phenazine, phenothiazine, phenoxazine, and acridine.

An example of the ionic liquid may include one or more solvent selected from a group consisting 1-butyl-3-methylpyridinium bromide, 1-butyl-4-methylpyridinium bromide, 1-butylpyridinium bromide, 1-butyl-2-methylpyridinium bromide, 1-hexylpyridinium bromide, 1-ethylpyridinium bromide, 1-propyl-2-methylpyridinium bromide, 1-propyl-3-methylpyridinium bromide, 1-propyl-4-methylpyridinium bromide, 1-propylpyridinium bromide, 1-ethyl-2-methylpyridinium bromide, 1-ethyl-3-methylpyridinium bromide, 1-ethyl-4-methylpyridinium bromide, 1-ethylpyridinium iodide, 1-butylpyridinium iodide, 1-hexylpyridinium iodide, 1-butyl-2-methylpyridinium iodide, 1-butyl-3-methylpyridinium iodide, 1-butyl-4-methylpyridinium iodide, 1-propylpyridinium iodide, 1-butyl-3-methylpyridinium chloride, 1-butyl-4-methylpyridinium chloride, 1-butylpyridinium chloride, 1-butyl-2-methylpyridinium chloride, 1-hexylpyridinium chloride, 1-butyl-3-methylpyridinium hexafluorophosphate, 1-butyl-4-methylpyridinium hexafluorophosphate, 1-butylpyridinium hexafluorophosphate, 1-ethylpyridinium hexafluorophosphate, 1-hexylpyridinium hexafluorophosphate, 1-butyl-2-methylpyridinium hexafluorophosphate, 1-propylpyridinium hexafluorophosphate, 1-butyl-2-methylpyridinium trifluoromethanesulfonate, 1-butyl-3-methylpyridinium trifluoromethanesulfonate, 1-butyl-4-methylpyridinium trifluoromethanesulfonate, 1-hexylpyridinium trifluoromethanesulfonate, 1-butylpyridinium trifluoromethanesulfonate, 1-ethylpyridinium trifluoromethanesulfonate, 1-propylpyridinium trifluoromethanesulfonate, 1-butyl-3-methylpyridinium hexafluorophosphate, 1-butyl-4-methylpyridinium hexafluorophosphate, 1-butylpyridinium hexafluorophosphate, 1-hexylpyridinium hexafluorophosphate, 1-butyl-2-methylpyridinium hexafluorophosphate, 1-ethylpyridinium hexafluorophosphate, 1-propylpyridinium hexafluorophosphate, 1-ethylpyridinium bis(trifluoromethylsulfonyl)imide, 1-propylpyridinium bis(trifluoromethylsulfonyl)imide, 1-butylpyridinium bis(trifluoromethylsulfonyl)imide, 1-ethyl-3-methylpyridinium bis(trifluoromethylsulfonyl)imide, 3-methyl-1-propylpyridinium bis(trifluoromethylsulfonyl)imide, 1-butyl-3-methylpyridinium bis(trifluoromethylsulfonyl)imide, 1-ethyl-4-methylpyridinium bis(trifluoromethylsulfonyl)imide, 4-methyl-1-propylpyridinium bis(trifluoromethylsulfonyl)imide, 1-butyl-4-methylpyridinium bis(trifluoromethylsulfonyl)imide, 1-butyl-2-methylpyridinium bis(trifluoromethylsulfonyl)imide, 1-ethyl-2-methylpyridinium bis(trifluoromethylsulfonyl)imde, 2-methyl-1-propylpyridinium bis(trifluoromethylsulfonyl, 1-ethyl-3-methylimidazolium methylcarbonate, 1-butyl-3-methylimidazolium methylcarbonate, 1-ethyl-3-methylimidazolium tricyanomethanide, 1-butyl-3-methylimidazolium tricyanomethanide, 1-ethyl-3-methylimidazolium bis(perfluoroethylsulfonyl)imide, 1-butyl-3-methylimidazolium bis(perfluoroethylsulfonyl)imide, 1-ethyl-3-methylimidazolium dibutylphosphate, 1-butyl-3-methylimidazolium dibutylphosphate, 1-ethyl-3-methylimidazolium methyl sulfate, 1,3-dimethylimidazolium methyl sulfate, 1-ethyl-3-methylimidazolium ethyl sulfate, 1,3-diethylimidazolium ethyl sulfate, 1,3-dimethylimidazolium dimethyl phosphate, 1-ethyl-3-methylimidazolium dimethyl phosphate, 1-butyl-3-methylimidazolium dimethyl phosphate, 1-ethyl-3-methylimidazolium diethyl phosphate, 1,3-diethylimidazolium diethyl phosphate, 1-butyl-3-methylimidazolium hydrogen sulfate, 1-ethyl-3-methylimidazolium hydrogen sulfate, 1-butyl-3-methylimidazolium methanesulfonate, 1-ethyl-3-methylimidazolium methanesulfonate, 1-ethyl-3-methylimidazolium tosylate, 1-ethyl-3-methylimidazolium 1,1,2,2-tetrafluoroethanesulfonate, 1-methyl-3-propylimidazolium 1,1,2,2-tetrafluoroethanesulfonate, 1-butyl-3-methylimidazolium 1,1,2,2-tetrafluoroethanesulfonate, 1-benzyl-3-methylimidiazolium 1,1,2,2-tetrafluoroethanesulfonate, 1-butyl-3-ethylimidazolium 1,1,2,2-tetrafluoroethanesulfonate, 1-methylimidazolium 1,1,2,2-tetrafluoroethanesulfonate, 1-ethylimidazolium 1,1,2,2-tetrafluoroethanesulfonate, 1-ethyl-3-methylimidazolium thiocyanate, 1-butyl-3-methylimidazolium thiocyanate, 1-ethyl-3-methylimidazolium dicyanamide, 1-butyl-3-methylimidazolium dicyanamide, 1-allyl-3-methylimidazolium dicyanamide, 1-benzyl-3-methylimidazolium dicyanamide, 1-methyl-3-propylimidazolium iodide, 1-hexyl-3-methylimidazolium iodide, 1-ethyl-3-methylimidazolium iodide, 1,2-dimethyl-3-propylimidazolium iodide, 1-butyl-3-methylimidazolium iodide, 1-dodecyl-3-methylimidazolium iodide, 1-butyl-2,3-dimethylimidazolium iodide, 1-hexyl-2,3-dimethylimidazolium iodide, 1,3-dimethylimidazolium iodide, 1-allyl-3-methylimidazolium iodide, 1-butyl-3-methylimidazolium chloride, 1-allyl-3-methylimidazolium chloride, 1-(2-hydroxyethyl)-3-methylimidazolium chloride, 1,3-didecyl-2-methylimidazolium chloride, 1-hexyl-3-methylimidazolium chloride, 1-butyl-2,3-dimethylimidazolium chloride, 1-decyl-3-methylimidazolium chloride, 1-methyl-3-octylimidazolium chloride, 1-ethyl-3-methylimidazolium chloride, 1-methylimidazolium chloride, 1-hexadecyl-3-methylimidazolium chloride, 1-dodecyl-3-methylimidazolium chloride, 1-benzyl-3-methylimidazolium chloride, 1-methyl-3-tetradecylimidazolium chloride, 1-methyl-3-propylimidazolium chloride, 1-methyl-3-octadecylimidazolium chloride, 1-ethylimidazolium chloride, 1,2-dimethylimidazolium chloride, 1-ethyl-2,3-dimethylimidazolium trifluoromethanesulfonate, 1-ethyl-3-methylimidazolium trifluoromethanesulfonate, 1-butyl-3-methylimidazolium trifluoromethanesulfonate, 1-butyl-2,3-dimethylimidazolium trifluoromethanesulfonate, 1-decyl-3-methylimidazolium trifluoromethanesulfonate, 1-hexyl-3-methylimidazolium trifluoromethanesulfonate, 1-methyl-3-octylimidazolium trifluoromethanesulfonate, 1-dodecyl-3-methylimidazolium trifluoromethanesulfonate, 1-methylimidazolium trifluoromethanesulfonate, 1-ethylimidazolium trifluoromethanesulfonate, 1-methyl-3-propylimidazolium trifluoromethanesulfonate, 1-ethyl-3-methylimidazolium acetate, 1-butyl-3-methylimidazolium acetate, 1-ethyl-3-methylimidazolium trifluoroacetate, 1-butyl-3-methylimidazolium trifluoroacetate, 1-ethyl-3-methylimidazolium nitrate, 1-methylimidazolium nitrate, 1-ethylimidazolium nitrate, 1-butyl-3-methylimidazolium tetrachloroferrate(III), 1-ethyl-3-methylimidazolium bis(trifluoromethylsulfonyl)imide, 1-methyl-3-propylimidazolium bis(trifluoromethylsulfonyl)imide, 1-butyl-3-methylimidazolium bis(trifluoromethylsulfonyl)imide, 1-hexyl-3-methylimidazolium bis(trifluoromethylsulfonyl)imide, 1-methyl-3-octylimidazolium bis(trifluoromethylsulfonyl)imide, 1-decyl-3-methylimidazolium bis(trifluoromethylsulfonyl)imide, 1-dodecyl-3-methylimidazolium bis(trifluoromethylsulfonyl)imide, 1-methyl-3-tetradecylimidazolium bis(trifluoromethylsulfonyl)imide, 1-hexadecyl-3-methylimidazolium bis(trifluoromethylsulfonyl)imide, 1-butyl-2,3-dimethylimidazolium bis(trifluoromethylsulfonyl)imide, 1-ethyl-2,3-dimethylimidazolium bis(trifluoromethylsulfonyl)imide, 1,2-dimethyl-3-propylimidazolium bis(trifluoromethylsulfonyl)imide, 1,3-diethylimidazolium bis(trifluoromethylsulfonyl)imide, 1,3-dimethylimidazolium bis(trifluoromethylsulfonyl)imide, 1-methyl-3-octadecylimidazolium bis(trifluoromethylsulfonyl)imide, 1-allyl-3-methylimidazolium bis(trifluoromethylsulfonyl)imide, 1-benzyl-3-methylimidazolium bis(trifluoromethylsulfonyl)imide, 1-methylimidazolium bis(trifluoromethylsulfonyl)imide, 1-ethylimidazolium bis(trifluoromethylsulfonyl)imide, 1,2-dimethylimidazolium bis(trifluoromethylsulfonyl)imide, 1-ethyl-3-propylimidazolium bis(trifluoromethylsulfonyl)imide, 1-butyl-3-ethylimidazolium bis(trifluoromethylsulfonyl)imide, 1-ethyl-3-vinylimidazolium bis(trifluoromethylsulfonyl)imide, 1-butyl-3-vinylimidazolium bis(trifluoromethylsulfonyl)imide, 1-methyl-3-pentylimidazolium bis(trifluoromethylsulfonyl)imide, 1-heptyl-3-methylimidazolium bis(trifluoromethylsulfonyl)imide, 1-methyl-3-nonylimidazolium bis(trifluoromethylsulfonyl)imide, 1-butyl-3-methylimidazolium hexafluorophosphate, 1-hexyl-3-methylimidazolium hexafluorophosphate, 1-methyl-3-octylimidazolium hexafluorophosphate, 1-butyl-2,3-dimethylimidazolium hexafluorophosphate, 1-decyl-3-methylimidazolium hexafluorophosphate, 1-dodecyl-3-methylimidazolium hexafluorophosphate, 1-ethyl-3-methylimidazolium hexafluorophosphate, 1-ethyl-2,3-dimethylimidazolium hexafluorophosphate, 1-methyl-3-propylimidazolium hexafluorophosphate, 1-methyl-3-tetradecylimidazolium hexafluorophosphate, 1-hexadecyl-3-methylimidazolium hexafluorophosphate, 1-methyl-3-octadecylimidazolium hexafluorophosphate, 1-benzyl-3-methylimidazolium hexafluorophosphate, 1,3-diethylimidazolium hexafluorophosphate, 1-ethyl-3-propylimidazolium hexafluorophosphate, 1-butyl-3-ethylimidazolium hexafluorophosphate, 1-methyl-3-pentylimidazolium hexafluorophosphate, 1-heptyl-3-methylimidazolium hexafluorophosphate, 1-methyl-3-nonylimidazolium hexafluorophosphate, 1-ethyl-2,3-dimethylimidazolium tetrafluoroborate, 1-ethyl-3-methylimidazolium tetrafluoroborate, 1-butyl-3-methylimidazolium tetrafluoroborate, 1-hexyl-3-methylimidazolium tetrafluoroborate, 1-methyl-3-octylimidazolium tetrafluoroborate, 1-(2-hydroxyethyl)-3-methylimidazolium tetrafluoroborate, 1-butyl-2,3-dimethylimidazolium tetrafluoroborate, 1-decyl-3-methylimidazolium tetrafluoroborate, 1-hexadecyl-3-methylimidazolium tetrafluoroborate, 1-dodecyl-3-methylimidazolium tetrafluoroborate, 1-methyl-3-propylimidazolium tetrafluoroborate, 1-benzyl-3-methylimidazolium tetrafluoroborate, 1-methyl-3-octadecylimidazolium tetrafluoroborate, 1-methyl-3-tetradecylimidazolium tetrafluoroborate, 1,3-diethylimidazolium tetrafluoroborate, 1-ethyl-3-propylimidazolium tetrafluoroborate, 1-butyl-3-ethylimidazolium tetrafluoroborate, 1-methyl-3-pentylimidazolium tetrafluoroborate, 1-heptyl-3-methylimidazolium tetrafluoroborate, 1-methyl-3-nonylimidazolium tetrafluoroborate, 1-ethyl-3-methylimidazolium bromide, 1-butyl-3-methylimidazolium bromide, 1-butyl-2,3-dimethylimidazolium bromide, 1-decyl-3-methylimidazolium bromide, 1-hexyl-3-methylimidazolium bromide, 1-methyl-3-octylimidazolium bromide, 1-methyl-3-propylimidazolium bromide, 1-dodecyl-3-methylimidazolium bromide, 1-ethyl-2,3-dimethylimidazolium bromide, 1,2-dimethyl-3-propylimidazolium bromide, 1-methylimidazolium bromide, 1-ethylimidazolium bromide, 1,3-diethylimidazolium bromide, 1-ethyl-3-propylimidazolium bromide, 1-butyl-3-ethylimidazolium bromide, 1-ethyl-3-vinylimidazolium bromide, 1-butyl-3-vinylimidazolium bromide, 1-heptyl-3-methylimidazolium bromide, 1-methyl-3-nonylimidazolium bromide, 1-(2-hydroxy-2-methyl-n-propyl)-3-methylimidazolium methanesulfonate, 1-methyl-1-propylpiperidinium bis(trifluoromethylsulfonyl)imide, 1-butyl-1-methylpiperidinium bis(trifluoromethylsulfonyl)imide, 1-butyl-1-methylpiperidinium trifluoromethanesulfonate, 1-methyl-1-propylpiperidinium trifluoromethanesulfonate, 1-methyl-1-propylpiperidinium hexafluorophosphate, 1-butyl-1-methylpiperidinium hexafluorophosphate, 1-methyl-1-propylpiperidinium tetrafluoroborate, 1-butyl-1-methylpiperidinium tetrafluoroborate, 1-methyl-1-propylpiperidinium bromide, 1-butyl-1-methylpiperidinium bromide, 1-butyl-1-methylpiperidinium iodide, 1-methyl-1-propylpiperidinium iodide, 1-butyl-1-methylpyrrolidinium bis(trifluoromethylsulfonyl)imide, 1-methyl-1-propylpyrrolidinium bis(trifluoromethylsulfonyl)imide, 1-methyl-1-octylpyrrolidinium bis(trifluoromethylsulfonyl)imide, 1-ethyl-1-methylpyrrolidinium bis(trifluoromethylsulfonyl)imide, 1-butyl-1-methylpyrrolidinium trifluoromethanesulfonate, 1-methyl-1-propylpyrrolidinium trifluoromethanesulfonate, 1-ethyl-1-methylpyrrolidinium trifluoromethanesulfonate, 1-butyl-1-methylpyrrolidinium hexafluorophosphate, 1-methyl-1-propylpyrrolidinium hexafluorophosphate, 1-ethyl-1-methylpyrrolidinium hexafluorophosphate, 1-butyl-1-methylpyrrolidinium tetrafluoroborate, 1-methyl-1-propylpyrrolidinium tetrafluoroborate, 1-ethyl-1-methylpyrrolidinium tetrafluoroborate, 1-butyl-1-methylpyrrolidinium bromide, 1-methyl-1-propylpyrrolidinium bromide, 1-ethyl-1-methylpyrrolidinium bromide, 1-butyl-1-methylpyrrolidinium chloride, 1-methyl-1-propylpyrrolidinium chloride, 1-butyl-1-methylpyrrolidinium iodide, 1-methyl-1-propylpyrrolidinium iodide, 1-ethyl-1-methylpyrrolidinium iodide, 1-butyl-1-methylpyrrolidinium dicyanamide, 1-methyl-1-propylpyrrolidinium dicyanamide, 1-butyl-1-methylpyrrolidinium 1,1,2,2-tetrafluoroethanesulfonate, 1-methyl-1-propylpyrrolidinium 1,1,2,2-tetrafluoroethanesulfonate, 1-butyl-1-methylpyrrolidinium methylcarbonate, 1-butyl-1-methylpyrrolidinium tricyanomethanide, methyltrioctylammonium bis(trifluoromethylsulfonyl)imide, butyltrimethylammonium bis(trifluoromethylsulfonyl)imide, choline bis(trifluoromethylsulfonyl)imide, tributylmethylammonium bis(trifluoromethylsulfonyl)imide, ethylammonium nitrate, methylammonium nitrate, propylammonium nitrate, dimethylammonium nitrate, butyltrimethylammonium methylcarbonate, methyltrioctylammonium methylcarbonate, N-ethyl-N-methylmorpholinium methylcarbonate, N,N-diethyl-N-methyl-N-(2-methoxyethyl)ammonium bis(trifluoromethylsulfonyl)-imide, N,N-diethyl-N-methyl-N-(2-methoxyethyl) ammonium tetrafluoroborate, butyltrimethylammonium 1,1,2,2-tetrafluoroethanesulfonate, tetraethylammonium 1,1,2,2-tetrafluoroethanesulfonate, 2-hydroxyethylammonium formate, choline dihydrogen phosphate, methyltrioctylammonium trifluoromethanesulfonate, trihexyltetradecylphosphonium bromide, tetrabutylphosphonium bromide, tetraoctylphosphonium bromide, trihexyltetradecylphosphonium chloride, tributyltetradecylphosphonium chloride, tributylmethylphosphonium methylcarbonate, trioctylmethylphosphonium methylcarbonate, trihexyltetradecylphosphonium decanoate, trihexyltetradecylphosphonium bis(2,4,4-trimethylpentyl)phosphinate, trihexyltetradecylphosphonium dicyanamide, triisobutylmethylphosphonium tosylate, trihexyltetradecylphosphonium hexafluorophosphate, tributylmethylphosphonium methyl sulfate, tetrabutylphosphonium chloride, ethyltributylphosphonium diethyl phosphate, tributyltetradecylphosphonium dodecylbenzenesulfonate, trihexyltetradecylphosphonium bis(trifluoromethylsulfonyl)imide, tributylmethylphosphonium 1,1,2,2-tetrafluoroethanesulfonate, triethylsulfonium bis(trifluoromethylsulfonyl)imide, diethylmethylsulfonium bis(trifluoromethylsulfonyl)imide, triethylsulfonium iodide, and trimethylsulfonium iodide.

In the sodium secondary battery according to the exemplary embodiment of the present invention, the solvent of the cathode solution may further contain a heterogeneous solvent having miscibility with the above-mentioned solvent. As an example of the heterogeneous solvent, there is at least one solvent selected from a group consisting of ethylene carbonate, propylene carbonate, 1,2-butylene carbonate, 2,3-butylene carbonate, 1,2-pentylene carbonate, 2,3-pentylene carbonate, vinylene carbonate, dimethyl carbonate, diethyl carbonate, di(2,2,2-trifluoroethyl) carbonate, dipropyl carbonate, dibutyl carbonate, ethylmethyl carbonate, 2,2,2-trifluoroethyl methyl carbonate, methylpropyl carbonate, ethylpropyl carbonate, 2,2,2-trifluoroethyl propyl carbonate, methyl formate, ethyl formate, propyl formate, butyl formate, dimethyl ether, diethyl ether, dipropyl ether, methylethyl ether, methylpropyl ether, ethylpropyl ether, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate, γ-butyrolactone, 2-methyl-γ-butyrolactone, 3-methyl-γ-butyrolactone, 4-methyl-γ-butyrolactone, γ-thiobutyrolactone, γ-ethyl-γ-butyrolactone, β-methyl-γ-butyrolactone, γ-valerolactone, σ-valerolactone, γ-caprolactone, ε-caprolactone, β-propiolactone, tetrahydrofuran, 2-methyl tetrahydrofuran, 3-methyl tetrahydrofuran, trimethyl phosphate, triethyl phosphate, tris(2-chloroethyl)phosphate, tris(2,2,2-trifluoroethyl)phosphate, tripropyl phosphate, triisopropyl phosphate, tributyl phosphate, trihexyl phosphate, triphenyl phosphate, tritolyl phosphate, methyl ethylene phosphate, ethyl ethylene phosphate, dimethyl sulfone, ethyl methyl sulfone, methyl trifluoromethyl sulfone, ethyl trifluoromethyl sulfone, methyl pentafluoroethyl sulfone, ethyl pentafluoroethyl sulfone, di(trifluoromethyl)sulfone, di(pentafluoroethyl) sulfone, trifluoromethyl pentafluoroethyl sulfone, trifluoromethyl nonafluorobutyl sulfone, pentafluoroethyl nonafluorobutyl sulfone, sulfolane, 3-methylsulfolane, 2-methylsulfolane, 3-ethylsulfolane, and 2-ethylsulfolane.

In the sodium secondary battery according to the exemplary embodiment of the present invention, the anode may contain an anode active material containing sodium, wherein the anode active material may contain a sodium metal or a sodium alloy. As a non-restrictive example, the sodium alloy may be an alloy of sodium and cesium, an alloy of sodium and rubidium, or a mixture thereof. The anode active material may be a solid-state material or a liquid-state material including a molten state material at the operation temperature of the battery. Here, in order to allow the battery to have capacity of 50 Wh/kg or more, the anode active material may be molten sodium (Na), and the operation temperature of the battery may be 98 to 200° C., substantially 98 to 150° C., and more substantially 98 to 130° C.

In the sodium secondary battery according to the exemplary embodiment of the present invention, as the sodium ion conductive solid electrolyte provided between the cathode and the anode, any material may be used as long as the material may physically separate the cathode and the anode from each other and have selective conductivity for the sodium ion. Therefore, a solid electrolyte generally used for selective conduction of the sodium ion in a battery field may be used. As a non-restrictive example, the solid electrolyte may be Na super ionic conductor (NaSICON), β-alumina, or β″-alumina. As a non-restrictive example, the NASICON may include Na—Zr—Si—O based complex oxide, Na—Zr—Si—P—O based complex oxide, Y-doped Na—Zr—Si—P—O based complex oxide, Fe-doped Na—Zr—Si—P—O based complex oxide, or a mixture thereof. In detail, the NASICON may include Na₃Zr₂Si₂PO₁₂, Na₁₊ₓSiₓZr₂P₃₋ₓO₁₂ (x is a real number satisfying the following inequality: 1.6<x<2.4), Y- or Fe-doped Na₃Zr₂Si₂PO₁₂, Y- or Fe-doped Na₁₊ₓSiₓZr₂P₃₋ₓO₁₂ (x is a real number satisfying the following inequality: 1.6<x<2.4), or a mixture thereof.

As the sodium secondary battery according to the present invention includes the graphite felt immersed in the cathode solution and formed with the grooves in the surface of the graphite felt facing the solid electrolyte as the current collector, the sodium secondary battery may have chemically excellent stability, the reaction area and the loading amount of the cathode solution may be large, and the decrease in the capacity of the battery caused by non-uniform electroplating and dissolution of the metal may be prevented, such that the sodium secondary battery may have stable charge and discharge cycle characteristics. In addition, the sodium secondary battery according to the present invention is configured to include the anode containing sodium, the solid electrolyte having selective conductivity for the sodium ions, and the cathode solution containing the solvent dissolving the cathode active metal halide, such that the sodium secondary battery may operate at a low temperature in a range from room temperature to 200° C., and the electrochemical reactions of the battery are carried out by the cathode active metal halide and the sodium halide dissolved in the cathode solution, such that capacity of the battery may be significantly increased, and an active region at which the electrochemical reactions are carried out may be increased, thereby making it possible to significantly increase a charge/discharge rate of the battery and prevent internal resistance of the battery from being increased.

Hereinabove, although the present invention is described by specific matters, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described embodiments, and the following claims as well as all modified equally or equivalently to the claims are intended to fall within the scope and spirit of the invention.

What is claimed is:

1. A sodium secondary battery comprising:
a sodium ion conductive solid electrolyte separating an anode space and a cathode space from each other;
an anode positioned in the anode space and containing sodium;
a cathode solution positioned in the cathode space; and
a cathode immersed in the cathode solution and including graphite felt formed with grooves arranged in parallel with each other in a surface of the graphite felt facing the solid electrolyte.

2. The sodium secondary battery of claim 1, wherein the groove transverses the surface of the graphite felt facing the solid electrolyte.

3. The sodium secondary battery of claim 1, wherein the groove has a uniform width in a depth direction.

4. The sodium secondary battery of claim 1, wherein the groove has a tapered shape in which a width thereof is decreased in a depth direction.

5. The sodium secondary battery of claim 4, wherein the groove is continuously formed.

6. The sodium secondary battery of claim 1, wherein a depth of the groove is 5 to 95% based on a thickness (100%) of the graphite felt.

7. The sodium secondary battery of claim 1, wherein a width of the groove is 0.1 to 30% based on a length (100%) of the graphite felt in a height direction.

8. The sodium secondary battery of claim 1, wherein the grooves are arranged in parallel with each other in a height direction.

9. The sodium secondary battery of claim 1, wherein the graphite felt has a hollow cylindrical or cylindrical shape, and the groove forms a closed curve.

10. The sodium secondary battery of claim 1, wherein a density of the groove corresponding to the number of grooves per unit length of the graphite felt is 0.1 to 10 ea/cm.

11. The sodium secondary battery of claim 1, further comprising a cylindrical metal housing of which one end is closed, and the other end is opened, wherein the cathode space and the anode space are partitioned from each other by a tube type solid electrolyte of which one end inserted into the metal housing is closed.

12. The sodium secondary battery of claim 1, wherein the cathode further contains a transition metal attached or loaded in the graphite felt.

13. The sodium secondary battery of claim 1, wherein the cathode solution contains: a metal halide corresponding to a halide of at least one metal selected from transition metals and Groups 12 to 14 metals; and a solvent dissolving the metal halide.

14. The sodium secondary battery of claim 13, wherein at the time of discharge, metal ions of the metal halide contained in the cathode solution are converted into a metal to thereby be electroplated on the graphite felt, and at the time of charge, the metal electroplated on the graphite felt is converted into the metal ions to thereby be dissolved in the cathode solution.
